(19) United States
(12) Patent Application Publication
(10) Pub. No.: US 2008/0277921 A1
(43) Pub. Date: Nov. 13, 2008

(54) Method and a Sleeve for Joining Two Components

(76) Inventors: Claes Ohngren, Uppsala (SE); Roger Berglund, Vasteras (SE); Thomas Lewin, Hallstahammar (SE)

Correspondence Address: Carter, DeLuca, Farrell & Schmidt, 445 Broad Hollow Road, Suite 225, Melville, NY, 11747, US

(21) Appl. No.: 11/795,333

(22) PCT Filed: Jan. 16, 2006
(86) PCT No.: PCT/SE2006/000055

§ 371 Date: Jan. 17, 2008

(30) Foreign Application Priority Data
Jan. 17, 2005 (SE) 0500128-4
Feb. 10, 2005 (SE) 0500323-1

(51) Int. Cl. F16L 55/00

(52) U.S. Cl. 285/24

(57) ABSTRACT

A method of joining at least two components (1, 2), such as tubes, where at least one of the components (1, 2) comprises, or is made of, a material which is difficult to weld, comprises the step of welding the components together and then thermally insulating the weld joint (3) using a sleeve (4) for example.

### TECHNICAL FIELD

The present invention concerns a method of joining at least two components, such as tubes, where at least one of the components comprises, or is made of, a material that is difficult to weld. The expression “material that is difficult to weld” means materials that at least partly lose their mechanical properties or corrosion resistance when welded, such as dispersion-strengthened alloys.

### BACKGROUND AND PRIOR ART

Interrupting the operation of a-large chemical facility involves a significant drop in productivity and loss of revenues for every hour the facility is out of service. Several routine maintenance operations require shutting down major portions of a facility until all work is completed. One such operation is the replacement of cracking furnace tubes used in the production of ethylene. The tubes used for furnace applications, such as steam crackers, have typical service temperatures in the range of 900-1200° C., they can be up to about 20 m long and are consequently quite heavy, and they usually transport corrosive or carbon-containing media. The tubes are mainly heated by radiation and convection from the outside however the temperature of components passing through the tubes may also contribute to heating the tubes from the inside. To withstand such high service temperatures, high loads and corrosive or carbonising environments, a number of heat resistant alloys, such as dispersion-strengthened alloys, are used. These alloys are specifically formulated to have the desired properties, such as good creep strength, but they pose significant welding problems.

The welding process can give rise to rearrangement, clustering or coarsening of carbide-, nitride- and/or oxide phases, which leads to a significant weakening of the weld joint. A significant joint strength can be difficult to achieve when the alloys are used at high temperatures. Welding such alloys together can therefore result in loss of the desired properties of the alloys in the area of the weld joint. This means that such weld joints may not be able to withstand the high temperatures that they are subjected to in certain parts of a cracking furnace.

EP 1418376 provides an alternative to welding such alloys. The patent describes pipes made of a difficult-to-weld material to be used at a high temperature which are internally and externally threaded-at their end portions and which are then thread-fastened to each other. A disadvantage with such pipes is that the mechanical stability of the jointed pipe portion is reduced since material has to be removed from the pipes when threads are cut into the pipes. A mechanically weaker structure implies a shorter life-time of the jointed pipe portion thus increasing labour and material costs. Furthermore, after joining the components together the inner and/or outer faces of the jointed pipe portion have to be sealed to retain the gas tightness of the jointed pipe portion. The manufacture and installation of such pipes is therefore more complex and time consuming than if the pipes were welded together. Finally, in order to benefit from the invention disclosed in this patent, existing welded pipes would have to be replaced with threaded pipes.

### SUMMARY OF THE INVENTION

The object of the invention is to provide a simple method of joining at least two components, such as tubes or finned tubes, wherein at least one of the components comprises a material that is difficult to weld, while accomplishing a joint with good mechanical stability which can withstand high temperature environments.

The object is fulfilled by a method that comprises the step of welding the components together and then thermally insulating the weld joint. The temperature that the difficult-to-weld material is subjected to at the weld joint is decreased by thermally insulating the weld joint from heat from the components' surroundings. The flow or composition of any medium flowing through such components being hollow will not therefore be altered as it passes through the joint structure. Furthermore, the insulation maintains the temperature inside the parts of the components inside the insulation, so that said parts are cooled down more slowly, which consequently reduces the risk of thermal shock of the weld joint. The insulation may also protect the weld joint from mechanical or chemical attack.

The inventive method results in a fluid-tight joint structure that is mechanically stable at high temperatures and easy to accomplish thus decreasing installation and replacement costs. The inventive method may be used to install a new system containing components that are difficult to weld or to improve existing systems without having to change the material type in such systems or change the design, such as a furnace design, thereof.

According to an embodiment of the invention said step of thermal insulation comprises an arrangement of a sleeve having thermal insulating properties to cover said weld joint and the areas of said components joined by said weld joint closest to said weld joint. Such a sleeve may efficiently insulate the weld joint thermally while substantially reducing the temperature to which the weld joint is subjected as well as reducing the speed of the temperature fall when the components are cooled down. Such a sleeve may be arranged outside said components and/or inside thereof depending upon the location of the source of the high temperatures to which the weld joint is exposed. Thus, according to a further embodiment of the invention said step of thermal insulation comprises an arrangement of a said sleeve outside said weld joint for surrounding said weld joint and said areas of the components for providing thermal insulation of the weld joint with respect to the exterior of said components, which is suitable for instance when the components are tubes arranged in a cracking furnace and heated from the outside.

According to another embodiment of the invention, in which components being hollow at least in the regions thereof to be joined by said weld joint, such as tubes, are to be joined, said step of thermal insulation comprises an arrangement of a said sleeve inside said components for covering said weld joint and said areas of the components closest to the weld joint for providing thermal insulation of the weld joint with respect to the interior of said components.

According to another embodiment of the invention it is a sleeve comprising an outer jacket, for instance made of metal or ceramic, at least partly filled with a refractory material, such as ceramic fibre, that is arranged outside said weld joint.

According to another embodiment of the invention it is a sleeve comprising an inner jacket, made of for example metal or ceramic, at least partly surrounded with a refractory material, such as ceramic fibre, that is arranged inside said components. The jacket may for example be of Kanthal APM, and said refractory material may for example be ceramic fibre or vacuum-formed ceramic fibre, such as Fibrothal (available from Kanthal). The refractory material may for instance be Kaewool 1260. Incorporating a compressible layer of refractory material between the inner/outer jacket of the sleeve and the outer/inner walls of the components will allow the sleeve to move more freely with respect to the welded components and any expansion or contraction caused by thermal expansion will not exert a force on the sleeve or the welded components, thereby prolonging their service life.

The sleeve may consist of a single component or a plurality of components which at least partly surround, or lie adjacent to the weld joint and it may have a cross section of any geometrical form, such as a circular or square cross section.

According to another embodiment of the invention the insulation is fixedly attached to at least one of the welded components.

According to a further embodiment of the invention in which said components to be joined are hollow, such as tubes, the method comprises the step of providing at least one of the components with thicker walls at the end(s) that is/are to be welded, (as compared to the thickness of the rest of said component(s)) by forging or turning for example, and attaching the thermal insulation thereto. According to yet a further embodiment of the invention the method comprises the step of providing the thicker walls with load-bearing means, such as one or more load-bearing shoulders, to support the thermal insulation. Only the end part(s) of the component(s) is/are made thicker since the components have to be able to carry their own weight and withstand bending moments. This means that the area of the weld joint may be increased so that the load per area to be resisted by the weld joint is lowered and the weld joint may be strong enough in spite of the lower mechanical strength thereof as a consequence of the difficult-to-weld property of at least one of said components. Increasing the thickness of the whole component would also give rise to higher material costs and adversely affect the components' heat transport properties.

According to another embodiment of the invention said material that is difficult to weld comprises a dispersion-strengthened alloy containing in weight-%: C up to 0.08, Si up to 0.7, Cr 10-25, Al 1-10, Mo 1.5-5, Mn up to 0.4, balance Fe and normally occurring impurities.

According to an alternative embodiment of the invention said material that is difficult to weld comprises Kanthal APM, an iron-chromium-aluminium (FeCrAl) alloy developed through Kanthal's Advanced Powder Metallurgy (APM) technology, or APMT i.e. a similar FeCrAl alloy base as Kanthal APM but with added molybdenum.

According to an embodiment of the invention such a material that is difficult to weld may be welded to a component that is easier or easy to weld, such as austenitic stainless steel, or to a component that is difficult to weld.

According to an embodiment of the invention said sleeve is supported by support means, such as a support ring.

According to a further embodiment the thermal insulation comprises a refractory material, a ceramic material or refractory fibre, such as aluminium silicate fibre. According to an embodiment of the invention the thermal insulation consists substantially entirely of a ceramic material or of a refractory fibre.

According to another embodiment of the invention the thermal insulation comprises a material that is difficult to weld.

According to an embodiment of the invention the method comprises the step of taking the temperature, via at least one thermocouple for example, at least one location on or around the weld joint and/or the insulation. The temperature of any medium flowing through the welded components or the temperature of the components can therefore be monitored and the thickness or type of insulation may be varied in order to achieve and maintain a desired temperature.

The present invention also concerns a sleeve for use in a method according to any of the embodiments described above and in the attached claims.

The method or sleeve according to any of the embodiments are intended for use particularly, but not exclusively in corrosive conditions or high temperature applications, such as at temperatures of 900° C. or higher, or for example in cracking furnaces or heat exchangers.

Further advantages as well as advantageous features of the invention appear from the following description and the other dependent claims.

### BRIEF DESCRIPTION OF THE DRAWING

FIG. 1 illustrates a thermally insulated weld joint according to an embodiment of the invention, and

FIG. 2 illustrates a thermally insulated weld joint according to another embodiment of the invention.

It should be noted that the figures are not drawn to scale and that the size of certain features has been exaggerated for the sake of clarity.

The following description and drawings are not intended to limit the present invention to the embodiments disclosed. The embodiments disclosed merely exemplifies the principles of the present invention.

### DETAILED DESCRIPTION OF THE INVENTION

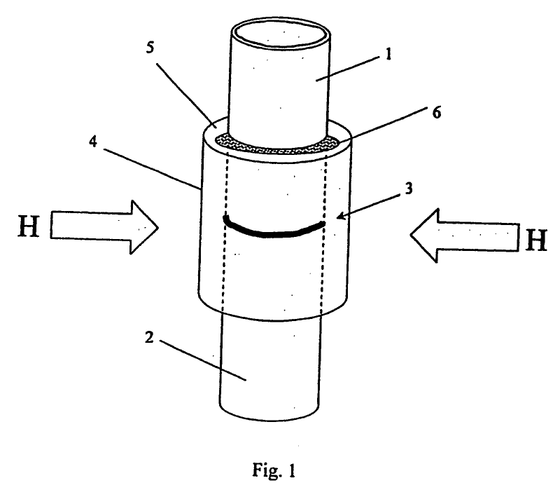

FIG. 1 illustrates two tubes 1, 2 which have been welded together at their ends. At least one or both of the two tubes 1, 2 is made of a material that is difficult to weld, such as an iron-based dispersion-strengthened material. The weld joint 3 provides a substantially precise fit without irregularities along the inner surfaces of the two tubes 1, 2, whose presence could otherwise adversely affect the flow of any medium flowing through the tubes.

The tubes 1, 2, may be heating pipes or high-temperature process pipes used in oil refineries, chemical- or petrochemical plants, power generation plants, steelmaking plants or nuclear power installations for example. Although the tubes 1, 2, in this example are of the same diameter the inventive joining method may be used to join tubes of different diameters and tubes having a plurality of branches.

The weld joint 3 and the area around the weld joint is surrounded by an external thermally insulating sleeve 4 which is held in place around the weld joint 3 by any conventional method. The sleeve 4 consists of either a single part, such as a cylindrical tube that completely surrounds the weld joint and which is moved over the weld joint 3 after welding or a plurality of parts, such as two halves of a cylindrical tube that are fastened around the weld joint 3 after welding.

The sleeve 4 shields the weld joint 3 from heat H that would otherwise increase the temperature of the tubes 1, 2, in the vicinity of the weld joint. The sleeve 4 comprises a metal or ceramic outer jacket 5 filled with a light-weight ceramic fibre 6. The outer jacket 5 better withstands any vibrations or corrosive gas flows which may occur in the environment surrounding the welded components 1, 2 and subsequently effect the weld joint 3. It has been found that the temperature of a weld joint can be decreased by at least about 50-100° C. and up to about 150° C. as compared to an un-insulated weld joint subjected to a temperature of about 1 110° C. The temperature of the weld joint was in fact reduced by about 90° C. when in such a case one of the components (tubes) was of a material difficult to weld in the form of Kanthal APM.

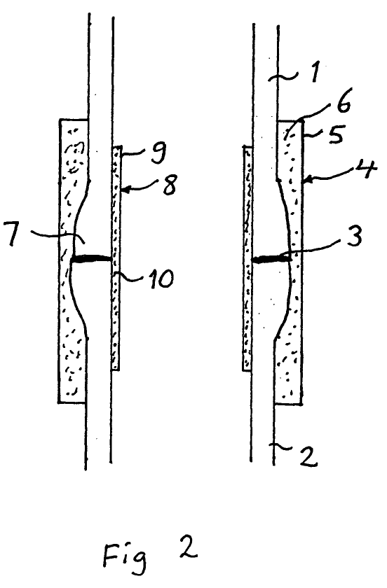

FIG. 2 illustrates schematically how two tubes 1, 2 are joined by a weld joint 3. It is here shown how the tubes are at the ends thereof to be welded provided with thicker walls 7 compared to the thickness of the rest of the tubes, for example by forging or turning resulting in the advantages of a lower load per area of the weld joint discussed above. The outer sleeve 4 may be fixedly attached to the tubes by utilizing the thicker walls 7 to prevent displacement of this sleeve with respect to the tubes transversely to the weld joint 3. It is here shown how the weld joint 3 may also be protected against heat coming from the interior of the components by arranging a sleeve 8 inside the components for covering the weld joint and areas of the components closest to the weld joint. This sleeve 8 may comprise an inner jacket 9, made of for example metal or ceramic, which is at least partly surrounded with a refractory material 10, such as ceramic fibre. This figure is only used for illustrating the arrangement of an inner sleeve inside components for protecting a weld joint against heat coming from the interior of the components, and that it is possible to arrange a thermally insulating sleeve outside and/or inside said components while bridging the weld joint.

The invention is of course not in any way restricted to the embodiments thereof described above, but many possibilities to modifications thereof would be apparent to a man with ordinary skill in the art without departing from the basic idea of the invention as defined in the appended claims.

It would for example be possible to provide a thermally insulating sleeve according to the invention with at least one air gap to decrease its thermal conductivity and thereby further insulate the area around a weld joint. Such an air gap in the sleeve would furthermore reduce the weight of the sleeve. Alternatively, an air gap may be provided between the sleeve and the components for the same purpose.

1. A method of joining at least two components (1,2), such as tubes, where at least one of the components (1,2) comprises, or is made of, a material which is difficult to weld, comprising a step of welding the components together and then a step of thermally insulating the weld joint (3).

2. A method according to claim 1, characterized in that wherein said step of thermal insulation comprises an arrangement of a sleeve (4, 8) having thermal insulating properties to cover said weld joint (3) and the areas of said components (1, 2) joined by said weld joint closest to said weld joint.

3. A method according to claim 2, characterized in that wherein said step of thermal insulation comprises an arrangement of a said sleeve (4) outside said weld joint (3) for surrounding said weld joint and said areas of the components (1, 2) for providing thermal insulation of the weld joint with respect to the exterior of said components.

4. A method according to claim 2, in which components (1, 2) being hollow at least in the regions thereof to be joined by said weld joint, such as tubes, are to be joined, wherein said step of thermal insulation comprises an arrangement of a said sleeve (8) inside said components for covering said weld joint (3) and said areas of the components closest to the weld joint for providing thermal insulation of the weld joint with respect to the interior of said components.

5. A method according to claim 3, wherein a sleeve (4) comprising an outer jacket (5), for instance made of metal or ceramic, at least partly filled with a refractory material (6), such as ceramic fiber, that is arranged outside said weld joint (3).

6. A method according to claim 4, wherein a sleeve (8) comprising an inner jacket (9), made of for example metal or ceramic, at least partly surrounded with a refractory material (10), such as ceramic fiber, is arranged inside said components.

7. A method according to claim 2, wherein a sleeve provided with at least one air gap t is arranged to cover said weld joint.

8. A method according to claim 2, wherein said sleeve (4, 8) is fixedly attached to at least one of said components (1, 2) joined by the weld joint.

9. A method according to claim 1, in which said components (1, 2) to be joined are hollow, such as tubes, characterized in that it comprises the step of providing at least one of the components (1, 2) with thicker walls (7) at the end(s) that is/are to be welded as compared to the thickness of the rest of said component(s) and attaching the thermal insulation thereto.

10. A method according to claim 9, comprising the step of providing the thicker walls (7) with load-bearing means, such as one or more load-bearing shoulders, to support the thermal insulation (4).

11. A method according to claim 2, wherein said sleeve (4) is supported by support means, such as a support ring.

12. A method according to claim 1, wherein said thermal insulation (4, 8) comprises a refractory material or a ceramic material.

13. A method according to claim 12, wherein said thermal insulation (4, 8) comprises refractory fiber, such as aluminium silicate fiber.

14. A method according to claim 1, wherein said material that is difficult to weld comprises a dispersion-strengthened alloy such as an alloy containing in weight-%:
C up to 0.08
Si up to 0.7
Al 1-10
Mo 1.5-5
Mn up to 0.4
balance Fe and normally occurring impurities.

15. A sleeve for use in a method according to claim 2 comprising a refractory material or a ceramic material.

16. A sleeve for use in a method according to claim 2 comprising refractory fiber, such as aluminium silicate fiber.

17. A sleeve for use in a method according to claim 3 comprising an outer jacket (5), for example made of metal or ceramic, at least partly filled with a refractory material (6), such as ceramic fiber.

18. A sleeve for use in a method according to claim 4 comprising an inner jacket (9), for example made of metal or ceramic, at least partly surrounded with a refractory material (10), such as ceramic fiber.

19. A sleeve for use in a method according to claim 2 wherein it, is provided with at least one air gap.

20. Use of a method according to claim 1 in corrosive conditions or high temperature applications, such as at temperatures of 900° C. or higher.

21. Use of a method according to claim 1 in cracking furnaces or heat exchangers.

22. Use of a sleeve according to claim 15 in corrosive conditions or high temperature applications, such as temperatures of 900° C. or higher.

23. Use of a sleeve according to claim 15 in cracking furnaces or heat exchangers.
